(19) United States
(12) Patent Application Publication
(10) Pub. No.: US 2008/0210261 A1
(43) Pub. Date: Sep. 4, 2008

(54) SUBSTRATE PROCESSING APPARATUS AND SUBSTRATE PROCESSING METHOD

(75) Inventors: Shuzo NAGAMI, Kyoto (JP); Hidehiko OZAKI, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 12/118,115

(22) Filed: May 9, 2008

Related U.S. Application Data
(62) Division of application No. 10/693,165, filed on Oct. 24, 2003, now abandoned.

(30) Foreign Application Priority Data
Oct. 28, 2002 (JP) 2002-312343
Aug. 19, 2003 (JP) 2003-295173

(51) Int. Cl. F26B 7/00; B08B 3/04

(52) U.S. Cl. 134/21

(57) ABSTRACT

A substrate processing apparatus for drying a substrate including a chamber, a vapor supply part, an open/close valve, and a controller, is disclosed. While the chamber is hermetically sealed, a substrate is cleaned by pure water. Water vapor of high temperature and pressure is thereafter supplied from the vapor supply part, to raise the temperature and pressure in the chamber. When the substrate surface is covered with pure water at a temperature of 100 degrees centigrade or higher, the controller brings the open/close valve to an open state to release the ambient atmosphere in the chamber in the atmosphere outside, thereby instantaneously bringing the chamber to a condition of reduced pressure. As a result, water mark formation caused by processing solution adhering to the substrate is suppressed in the drying process.

### CROSS REFERENCE TO RELATED APPLICATIONS

This is a divisional of U.S. patent application Ser. No. 10/693,165, filed Oct. 24, 2003, in the name of Shuzo NAGAMI and Hidehiko OZAKI, entitled SUBSTRATE PROCESSING APPARATUS AND SUBSTRATE PROCESSING METHOD. Which claims priority of Japanese Patent Application No. 2002-312343, filed Oct. 28, 2002, and Japanese Patent Application No.: 2003-295173 filed Aug. 19, 2003, the contents of which are incorporated herein by reference.

### BACKGROUND OF THE INVENTION

1. Field of the Invention

In a manufacturing process of a semiconductor substrate or a substrate for liquid crystal (which will be simply referred to as a “substrate”), the present invention relates to a technique of drying a processing solution adhered to such substrates after being subjected to a process step such as cleaning.

2. Description of the Background Art

The manufacturing process of a substrate includes exposure, developing process or etching to form a circuit or a pattern on a substrate surface (objective surface). These process steps require a developer or a chemical solution for etching, which should be removed from the substrate after completion of such steps to avoid adverse effect on other process steps. Therefore, cleaning and drying are performed subsequently to the process steps using such solutions.

In a drying process of a substrate, a substrate surface should be prevented from water droplet-shaped damage which is a so-called water mark. Water marks mainly result from chemical reaction between oxygen dissolved in an aqueous solution and silicon as a substrate material, and are likely to occur when a small amount of water is adhered to the substrate.

In response, a substrate processing apparatus has been suggested which performs drying process while preventing generation of these water marks. According to such a conventional substrate processing apparatus, while rotating a substrate after being subjected to cleaning by a processing solution (pure water) and sputtering the processing solution by means of a centrifugal force generated by rotation, nitrogen is sprayed onto the substrate to dry the processing solution. The substrate is thereby dried in a low oxygen atmosphere, leading to suppression of water mark formation.

On the other hand, the conventional substrate processing apparatus cannot completely remove oxygen from an atmosphere. Further, drying proceeds by evaporation of a processing solution. That is, a long period of time is eventually required for a small quantity of residual processing solution to be completely removed by drying, leading to formation of water marks on a substrate surface.

### SUMMARY OF THE INVENTION

In a manufacturing process of a semiconductor substrate or a substrate for liquid crystal (which will be simply referred to as a “substrate”), the present invention is intended for a technique of drying a processing solution adhered to such substrates after being subjected to a process step such as cleaning.

According to one aspect of the present invention, a substrate processing apparatus for drying a processing solution adhered to a substrate comprises: a processing chamber for isolating an ambient atmosphere of a substrate from outside; a holding element for holding a substrate in the processing chamber; a heating and pressure element for realizing rise in temperature and pressure in the processing chamber; and a release element for releasing an atmosphere in the processing chamber in an external atmosphere existing outside the processing chamber, wherein the release element releases an atmosphere in the processing chamber when the processing solution in the processing chamber is placed at a temperature which is a boiling point of the processing solution in the external atmosphere or higher.

When the processing solution in the processing chamber is placed at a temperature which is a boiling point of the processing solution in the external atmosphere or higher, the atmosphere in the chamber is released to cause the processing solution to evaporate in a short period of time in the processing chamber. As a result, water mark formation is suppressed.

According to another aspect of the present invention, a substrate processing apparatus for performing predetermined processing on a substrate comprises: a processing chamber for storing a substrate and a processing solution; a holding element for holding a substrate in the processing chamber; a drainage element for draining a processing solution stored in the processing chamber; and a vapor supply element for supplying vapor to the processing chamber, the vapor being generated from a solution which is of the same type as the processing solution, wherein the vapor is supplied from the vapor supply element to the processing chamber while the drainage element drains the processing solution stored in the processing chamber.

While draining the processing solution stored in the processing chamber, vapor generated from a predetermined solution is supplied to the processing chamber. As a result, the processing solution can dry in a high temperature and low humidity atmosphere, whereby the processing solution adhered to the substrate can be removed by drying with a high degree of efficiency.

It is therefore an object of the present invention to suppress water mark formation in the process step of removing the processing solution adhered to the substrate surface by drying.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view of a substrate processing apparatus according to a first preferred embodiment of the present invention;

FIG. 2 is a flowchart showing the operation of the substrate processing apparatus according to the first preferred embodiment;

FIG. 3 is a schematic view of a substrate processing apparatus according to a second preferred embodiment of the present invention;

FIGS. 4 and 5 are flowcharts showing the operation of the substrate processing apparatus according to the second preferred embodiment;

FIG. 6 illustrates a state in which pure water is supplied to a chamber;

FIG. 7 illustrates a state in which supply of superheated vapor to a chamber is started;

FIG. 8 illustrates a state in which a substrate is partially exposed by means of drainage of pure water;

FIG. 9 illustrates how nitrogen is supplied in the second preferred embodiment;

FIG. 10 is a schematic view of a substrate processing apparatus according to a third preferred embodiment of the present invention;

FIGS. 11 and 12 are flowcharts showing the operation of the substrate processing apparatus according to the third preferred embodiment;

FIG. 13 illustrates how a substrate is held in a chamber by a holding mechanism;

FIG. 14 illustrates a state in which supply of superheated vapor to a chamber is started;

FIG. 15 illustrates how a holding mechanism upwardly moves a substrate;

FIG. 16 illustrates a state in which upward movement of a substrate by a holding mechanism is finished; and

FIG. 17 illustrates how nitrogen is supplied in the third preferred embodiment.

### DESCRIPTION OF THE PREFERRED EMBODIMENTS

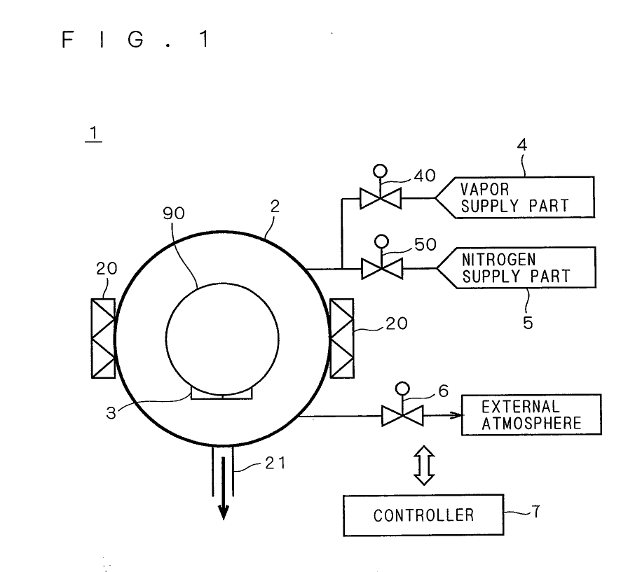

FIG. 1 is a schematic view of a substrate processing apparatus 1 according to the present invention. The substrate processing apparatus 1 of a first preferred embodiment processes a circular semiconductor substrate as an objective substrate 90 for forming an electric device such as an LSI. The substrate processing apparatus 1 is operative to function as a drying apparatus for drying of pure water (processing solution) adhered to the substrate 90. The application of the substrate processing apparatus 1 is not limited to a semiconductor substrate. As modifications, the substrate processing apparatus 1 is generally applied as an apparatus for drying of adhered pure water to a rectangular glass substrate for forming a display panel of a liquid crystal display device, or other types of substrates for a flat panel display.

The substrate processing apparatus 1 comprises a chamber 2 for isolating an ambient atmosphere of the substrate 90 from outside, a holding mechanism 3 for holding the substrate 90 at an approximate standstill in the chamber 2, a vapor supply part 4 for supplying the chamber 2 with heated water vapor, a nitrogen supply part 5 for supplying the chamber 2 with nitrogen gas as inert gas, an open/close valve 6 for releasing the atmosphere of the chamber 2 in an external atmosphere, and a controller 7 for controlling each constituent part of the substrate processing apparatus 1.

The chamber 2 is provided with heaters 20 and a drain 21, and is operative to function as a processing chamber for performing process steps to be described later to the substrate 90. The chamber 2 has approximately spherical internal space as shown in FIG. 1. Even when the chamber 2 is placed under high pressure inside, uniform application of pressure to the chamber 2 is allowed accordingly.

The chamber 2 is thermally insulated to avoid heat dissipation to outside, whereby temperature drop of the atmosphere in the chamber 2 can be controlled. To provide thermal insulation of the chamber 2, any known techniques may be applicable. By way of example, the chamber 2 may be covered with a thermally insulating material.

The chamber 2 is further provided with a lid member which is not shown. Opening of such a lid member allows the substrate 90 to be transported to and from the chamber 2 by means of a transport mechanism not shown.

The heaters 20 are operative to heat the atmosphere in the chamber 2, to prevent temperature drop of the atmosphere in the chamber 2. The drain 21, arranged at the lower portion of the chamber 2, is operative to drain liquid (mainly containing pure water) from the chamber 2 to outside, whereby liquid is prevented from gathering in the chamber 2.

The holding mechanism 3 is operative to transfer the substrate 90 to and from the foregoing transport mechanism, and to hold more than one substrate 90 at a predetermined position. In the first preferred embodiment, the holding mechanism 3 is operative to simultaneously hold fifty substrates 90. However, the number of the substrates 90 is not naturally limited to this.

The vapor supply part 4 is provided with a solenoid valve 40 which is opened or closed on the basis of a control signal given from the controller 7. The vapor supply part 4 includes a mechanism (not shown) for heating water vapor under pressure. When the solenoid valve 40 is brought to an open state, this mechanism supplies pure water of high temperature and pressure to the chamber 2, thereby realizing rise in temperature and pressure in the chamber 2. That is, the vapor supply part 4 is a main heating and pressure element of the present invention. In the first preferred embodiment, the vapor supply part 4 supplies water vapor at 100 degrees centigrade or higher.

The nitrogen supply part 5 is provided with a solenoid valve 50 which is opened or closed on the basis of a control signal given from the controller 7. When the solenoid valve 50 is brought to an open state, the nitrogen supply part 5 supplies nitrogen gas to the chamber 2. As inert gas, nitrogen may be replaced by argon gas or neon gas.

The open/close valve 6 is provided on a path arranged in an atmosphere which provides communication between the atmosphere in the chamber 2 and the external atmosphere. When the open/close valve 6 is in a closed state, the atmosphere in the chamber 2 and the external atmosphere are isolated from each other. When the open/close valve 6 is in an open state, the atmosphere in the chamber 2 is released in the external atmosphere. In the first preferred embodiment, the atmosphere is used as an external atmosphere existing outside the chamber 2. However, the external atmosphere is not limited to this. By way of example, an atmosphere after being subjected to pressure reduction by a blower, for example, may be applicable as an external atmosphere. That is, as long as pressure reduction in the chamber 2 is allowed to a sufficient degree at the instant when the open/close valve 6 is brought to an open state, an alternative atmosphere may be applicable as an external atmosphere. On the other hand, use of the atmosphere as an external atmosphere as in the first preferred embodiment requires no separate mechanism for pressure reduction, resulting in simplification of the apparatus configuration.

The controller 7 is connected to the chamber 2, holding mechanism 3, vapor supply part 4, nitrogen supply part 5, and open/close valve 6 through cables not shown in such a manner that signals are transmitted between the controller 7 and each of these constituent parts. The controller 7 is operative to store programs and various types of data, to generate control signals by suitably processing various types of data according to these programs, and to control configuration of each constituent part. These programs and various types of data are stored in a RAM for temporarily storing information thereof, a read-only memory (ROM), a magnetic disk device, or the like.

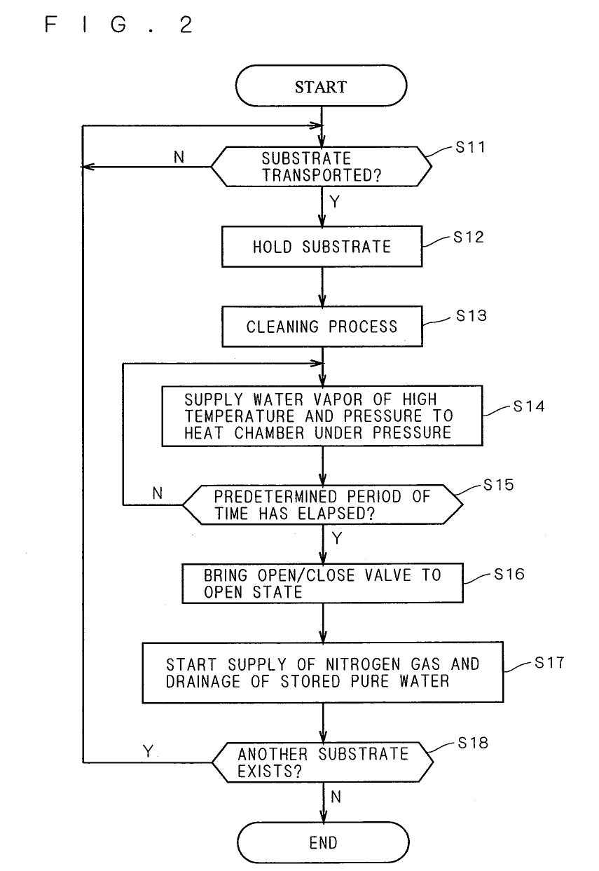

The main configuration of the substrate processing apparatus 1 is as described above. Next, it is discussed how the substrate 90 is processed by the substrate processing apparatus 1. FIG. 2 is a flowchart showing the operation of the substrate processing apparatus 1 of the first preferred embodiment. Unless otherwise indicated, the operation of each constituent part is controlled by the controller 7 in the following discussion.

Prior to the process flow of FIG. 2, predetermined initialization is performed in the substrate processing apparatus 1. Further, the vapor supply part 4 heats pure water under pressure to generate water vapor of high temperature and pressure.

Next, the substrate processing apparatus 1 is brought to a standby state, which state continues until the substrate 90 is transported to the chamber 2 by the transport mechanism not shown (step S11). When the substrate 90 is transported, that is, when the result of step S11 is Yes, the lid member not shown is driven to hermetically seal the chamber 2 and the transported substrate 90 is held by the holding mechanism 3 at a predetermined position (step S12).

The substrate processing apparatus 1 thereafter performs a cleaning process (step S13), in which process pure water is discharged from a nozzle which is not shown onto the substrate 90 held in the chamber 2, whereby the substrate 90 is cleaned. This cleaning process continues for a prescribed period of time, and thereafter, discharge of the pure water from the nozzle is stopped and the pure water gathering in the chamber 2 is drained through the drain 21. In this cleaning process, heated pure water may be discharged from the nozzle. Further, drainage of pure water through the drain 21 may be concurrent with discharge of pure water from the nozzle.

After the cleaning process of step S13, the vapor supply part 4 brings the solenoid valve 40 to an open state on the basis of a control signal given from the controller 7. The water vapor of high temperature and pressure previously generated is thus supplied from the vapor supply part 4 to the chamber 2, whereby the chamber 2 is heated under pressure (step S14).

As a result, rise in temperature and pressure in the chamber 2 occurs, thereby bringing the chamber 2 to a condition where the chamber 2 is capable of containing hot water at 100 degrees centigrade or higher. As the chamber 2 is provided with thermal insulation, temperature drop in the chamber 2 is suppressed. Further, the atmosphere in the chamber 2 is heated by the heaters 20, and therefore, temperature rise of the atmosphere in the chamber 2 can be realized with a high degree of efficiency.

The substrate processing apparatus 1 continues supply of water vapor from the vapor supply part 4 for a prescribed period of time (step S15). Hot water condenses on a surface of the substrate 90 accordingly, to cover the substrate 90.

After the prescribed period of time has elapsed and the pure water adhered to the substrate 90 has turned into hot water, the controller 7 brings the open/close valve 6 to an open state. The atmosphere in the chamber 2 is thereby released in the external atmosphere, bringing the chamber 2 to a condition of reduced pressure (step S16). The time required to change the pure water in the chamber 2 to hot water is previously measured and stored in the controller 7 as this prescribed period of time.

The first preferred embodiment uses the atmosphere as an external atmosphere. That is, the open state of the open/close valve 6 causes the inside of the chamber 2 to be released in the atmosphere, at approximately 1 atmospheric pressure with a boiling point of pure water at 100 degrees centigrade. As a result, hot water at 100 degrees centigrade or higher cannot exist, thus instantaneously boiling to be brought to gaseous form on the surface of the substrate 90. Even when a slight amount of water remains on the surface, such residual water evaporates in a short period of time by means of heat stored in the substrate 90 itself.

As discussed, in the substrate processing apparatus 1, the open/close valve 6 causes the atmosphere in the chamber 2 to be released in the external atmosphere at the time when the pure water existing in the chamber 2 is placed at a temperature which is a boiling point of pure water in the external atmosphere (100 degrees centigrade) or higher. As a result, the pure water in the chamber 2 can evaporate in a short period of time, whereby water mark formation is suppressed.

Thereafter, the solenoid valve 50 of the nitrogen supply part 5 is brought to an open state, whereby supply of nitrogen gas starts from the nitrogen supply part 5 to the chamber 2 and the pure water gathering in the chamber 2 is drained to the outside of the chamber 2 through the drain 21 (step S17).

In the substrate processing apparatus 1, temperature drop occurs in the chamber 2 when the substrate 90 is transported from the chamber 2 in a subsequent process step. That is, the water vapor existing in the chamber 2 will condense, causing probability of readhesion of pure water to the surface of the substrate 90. In response, in the substrate processing apparatus 1, nitrogen gas is supplied to the chamber 2 released in the external atmosphere, which replaces the water vapor existing in the chamber 2. As a result, such readhesion of pure water is prevented.

Drainage of the pure water gathering in the chamber 2 to outside avoids regeneration of water vapor in the chamber 2, whereby readhesion of pure water is prevented with a higher degree of effectiveness.

Next, the foregoing lid member is driven to open the chamber 2. The transport mechanism not shown thereafter receives the substrate 90 held by the holding mechanism 3 and transports the same from the chamber 2.

The substrate processing apparatus 1 then judges whether another objective substrate 90 exists (step S18). If there is another objective substrate 90, the process flow starting from step S11 is repeated to process this substrate 90. If there is no objective substrate 90, the process flow ends.

As discussed, in the substrate processing apparatus 1 of the first preferred embodiment, the chamber 2 is heated under pressure. The pure water in the chamber 2 is thereby placed at a temperature which is a boiling point of pure water in the external atmosphere or higher, under which condition the open/close valve 6 is brought to an open state to release the atmosphere in the chamber 2 in the external atmosphere. The chamber 2 is thus instantaneously brought to a condition of reduced pressure so that the pure water (hot water) adhered to the substrate 90 can evaporate. As a result, a small amount of pure water remains on the surface of the substrate 90 for a shorter period of time as compared with the conventional substrate processing apparatus, leading to suppression of water mark formation on the surface of the substrate 90. That is, poor drying of the substrate 90 is prevented.

To suppress water mark formation in a drying process of a substrate, it is important to rapidly dry a processing solution adhered to the substrate 90 as mentioned. As a technique therefor, high temperature and low humidity are an effective atmosphere.

FIG. 3 illustrates a substrate processing apparatus 1a according to a second preferred embodiment of the present invention that is responsive to this principle.

The substrate processing apparatus 1a comprises a chamber 2a, pipes 22 and 23, a heater 41, open/close valves 60 through 62, and a pure water supply part 8. The substrate processing apparatus 1a comprises the substantially similar constituent parts in functionality to those of the substrate processing apparatus 1. These parts are designated by the same reference numerals and the description thereof will be omitted, where appropriate.

The chamber 2a holds the substrate 90 therein, and is operative to function as a processing chamber for storing pure water. The pipe 22, provided with the open/close valve 62, is arranged at the upper portion of the chamber 2a. The pipe 23, provided with the open/close valves 60 and 61, is arranged at the bottom portion of the chamber 2a.

The pipe 22 is located at a position above the upper end of the substrate 90 held in the chamber 2, and is operative to communicatively provide connection between the inside and the outside of the chamber 2a. The open/close valve 62 controls the opening/closing operation of the pipe 22. In the substrate processing apparatus 1a, pure water is supplied from the pure water supply part 8 to the chamber 2a as to be described later. When the pure water supplied from the pure water supply part 8 exceeds a predetermined amount, overflow of the pure water occurs from the upper portion of the chamber 2a. The overflowing pure water is drained to the outside of the chamber 2a through the pipe 22. That is, the open/close valve 62 brings the pipe 22 to an open state to control the liquid surface of the pure water in the chamber 2a to a level lower than the position at which the pipe 22 is provided, whereby the amount of pure water existing in the chamber 2a is so controlled that it does not exceed the predetermined amount. When a substance in gaseous form such as water vapor or nitrogen gas is supplied to the chamber 2a, the atmosphere in the chamber 2a is exhausted to outside through the pipe 22. Namely, the pipe 22 is operative to function as an exhaust pipe and a drain pipe.

When the open/close valve 60 is in a closed state and the open/close valve 61 is in an open state, the pipe 23 becomes operative in a same manner as the drain 21 of the first preferred embodiment. That is, the pure water existing in the chamber 2a is drained through the pipe 23. When the open/close valve 60 is in an open state and the open/close valve 61 is in a closed state, pure water supplied from the pure water supply part 8 is introduced into the chamber 2a through the pipe 23. Namely, the pipe 23 is operative to function as a drain pipe and a water supply pipe.

The heater 41 is operative to heat the water vapor supplied from the vapor supply part 4 to the chamber 2a to generate superheated vapor. In the substrate processing apparatus 1a of the second preferred embodiment, the heater 41 heats the water vapor to be supplied to the chamber 2a to a temperature of around 170 degrees centigrade. Superheated vapor, which provides high temperature and low humidity condition, has a high heat capacity. Especially, superheated vapor at around 170 degrees centigrade excellently exhibits little fluctuation in drying performance regardless of variation in humidity. Therefore, use of such superheated vapor in the substrate processing apparatus 1a controls lot-to-lot variation of the substrate 90. However, the temperature of superheated vapor is not limited to this.

The pure water supply part 8 is operative to supply pure water from a tank not shown to the chamber 2a.

The main configuration of the substrate processing apparatus 1a of the second preferred embodiment is as described above. The operation of the substrate processing apparatus 1a will be discussed next.

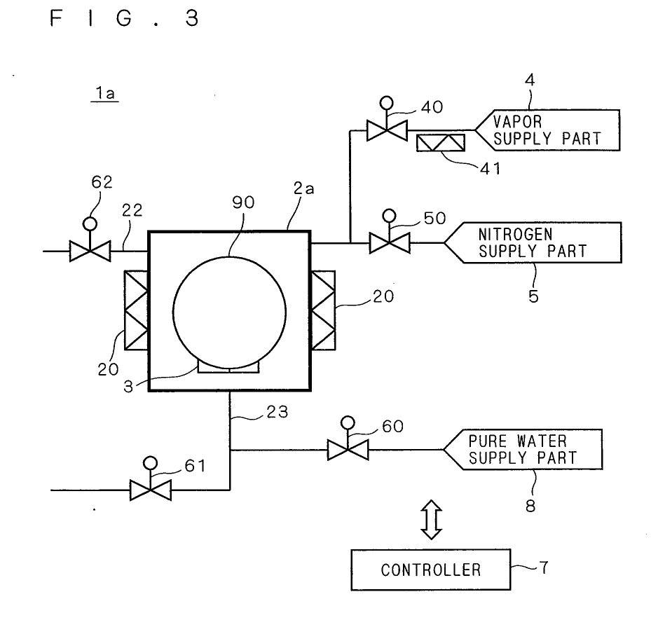

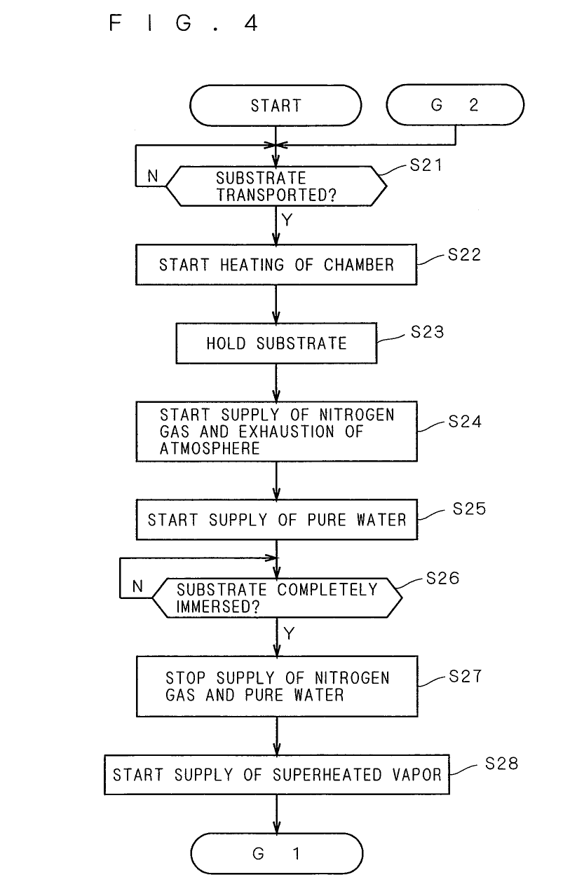

FIGS. 4 and 5 are flowcharts showing the operation of the substrate processing apparatus 1a of the second preferred embodiment. FIGS. 6 through 9 schematically illustrate states of the chamber 2a when the substrate processing apparatus 1a is in an operating state. Unless otherwise indicated, the operation of the substrate processing apparatus 1a is controlled by control signals given from the controller 7.

First, step S21 brings the substrate processing apparatus 1a to a standby state, which state continues until the substrate 90 is transported to the chamber 2a. When the substrate 90 is transported to the chamber 2a, the heaters 20 start heating of the atmosphere in the chamber 2a (step S22) and the holding mechanism 3 holds the substrate 90 at a predetermined position (step S23). The heaters 20 continue heating until step S38 to be described later is executed.

Thereafter, the solenoid valve 50 is brought to an open state to start supply of nitrogen gas from the nitrogen supply part 5 to the chamber 2a (step S24). At this stage, the open/close valve 62 is brought to an open state to exhaust the atmosphere from the chamber 2a through the pipe 22. The nitrogen gas thereby replaces the atmosphere in the chamber 2a so that the chamber 2a is placed in a low oxygen atmosphere. The open/close valves 60 and 61 may be respectively brought to a closed state and an open state at this stage to realize exhaustion of the atmosphere through the pipe 23, whereby the atmosphere containing oxygen is prevented from remaining in the bottom portion of the chamber 2. Supply of nitrogen gas by the nitrogen supply part 5 continues until to-be-discussed step S27.

Next, the controller 7 brings the open/close valves 60 and 61 to an open state and a closed state, respectively, whereby the pure water supply part 8 starts supply of pure water to the chamber 2a through the pipe 23 (step S25). Supply of the pure water from the pure water supply part 8 causes rise in liquid level of the pure water in the chamber 2a higher relative to the substrate 90 at a standstill, whereby the substrate 90 is gradually immersed in the pure water. The substrate processing apparatus 1a is placed in a standby state until pure water of a predetermined amount or more is supplied from the pure water supply part 8 (step S26).

FIG. 6 illustrates a state in which pure water of the predetermined amount or more is supplied from the pure water supply part 8 by execution of step S25. In this state, the substrate 90 is completely immersed in the pure water, and therefore, the result of step S26 is Yes. The liquid surface of the pure water rises to a level up to the position at which the pipe 22 is provided to cause overflow of supplied pure water, which is then drained to the outside of the chamber 2a through the pipe 22.

As clearly seen from FIG. 6, in the substrate processing apparatus 1a of the second preferred embodiment, gas volume in the chamber 2a is considerably small when overflow of the pure water occurs. Further, nitrogen gas continues to replace the atmosphere in the chamber 2a, and therefore, oxygen concentration can sufficiently be reduced in the atmosphere. As a result, water mark formation is suppressed a to-be-discussed drying process of the substrate 90.

When the substrate 90 is completely immersed, the substrate processing apparatus 1a switches both the solenoid valve 50 and the open/close valve 60 to a closed state, whereby supply of nitrogen gas from the nitrogen supply part 5 and supply of pure water from the pure water supply part 8 stop (step S27). Further, the heater 41 starts heating of water vapor and the solenoid valve 40 is brought to an open state, to thereby start supply of superheated vapor from the vapor supply part 4 (step S28).

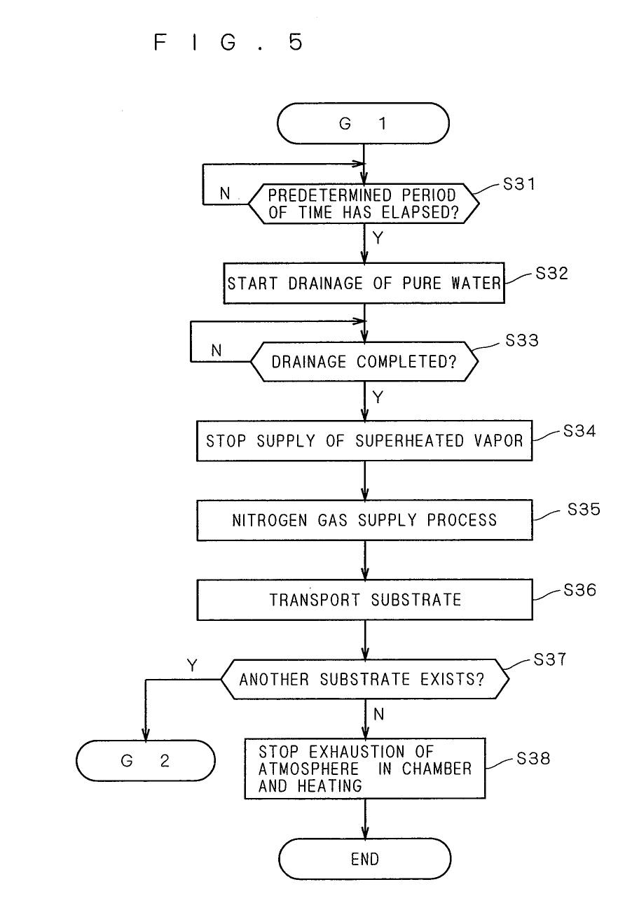

FIG. 7 illustrates a state in which the substrate processing apparatus 1a starts supply of the superheated vapor. The substrate processing apparatus 1a is placed in a standby state for a prescribed period of time during supply of the superheated vapor (step S31). The atmosphere in the chamber 2a is thus replaced by the superheated vapor.

After the prescribed period of time has elapsed, the substrate processing apparatus 1a brings the open/close valve 61 to an open state to start drainage of the pure water existing in the chamber 2a through the pipe 23 (step S32). The substrate processing apparatus 1a is then placed in a standby state until drainage of the pure water is completed (step S33), in which state supply of the superheated vapor from the vapor supply part 4 continues. That is, while draining the pure water stored in the chamber 2a through the pipe 23, the substrate processing apparatus 1a continues to supply the superheated vapor from the vapor supply part to the chamber 2a.

Drainage of the pure water from the chamber 2a causes drop in liquid level of the pure water relative to the substrate 90, to thereby gradually expose the surface of the substrate 90 to the atmosphere in the chamber 2a. With reference to step S33, it may be judged whether the substrate processing apparatus 1a is to be released from the standby state on the basis of a certain period of time which is sufficient enough to dry the substrate 90.

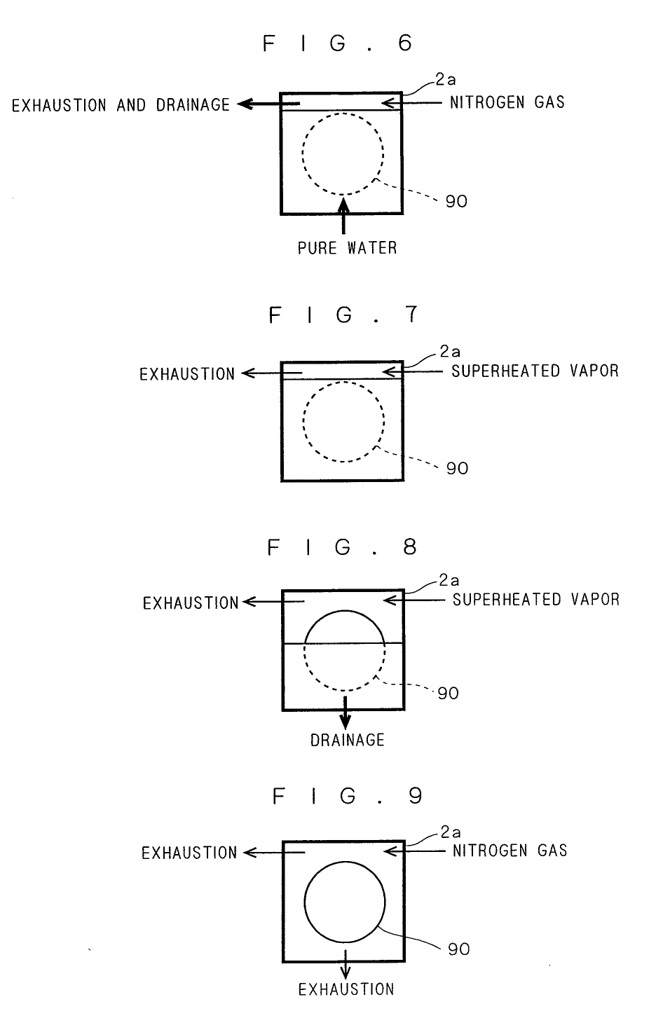

FIG. 8 illustrates a state in which the substrate 90 is partially exposed by means of drainage of pure water. The pure water adhered to the substrate 90 is exposed to the atmosphere in the chamber 2a, to rapidly evaporate by the superheated vapor. That is, such pure water is removed from the substrate 90 by drying. The atmosphere experiencing rise in humidity as a result of this removal of the pure water is exhausted through the pipe 22, and is replaced by the superheated vapor supplied from the vapor supply part 4.

As discussed, in the substrate processing apparatus 1a of the second preferred embodiment, the substrate 90 is dried in an atmosphere which has been replaced in advance by nitrogen gas and superheated vapor. It is thus allowed to dry the substrate 90 in a low oxygen atmosphere, resulting in suppression of water mark formation.

The chamber 2a is heated by the heaters 20 in the process flow, and therefore, temperature drop of the atmosphere in the chamber 2a is controlled in the drying process of the substrate 90. As a result, the pure water (processing solution) adhered to the substrate 90 can be removed by drying with a high degree of efficiency.

The heater 41 generates superheated vapor from water vapor which is then supplied to the chamber 2a, and therefore, the chamber 2a can be placed in a high temperature and low humidity atmosphere which is suitably applied for drying. As a result, pure water can dry with a higher degree of efficiency and the atmosphere is provided with an enhanced heat capacity, leading to improved control of temperature drop.

To avoid rapid drop in liquid level of the pure water relative to the substrate 90, drainage of the pure water through the pipe 23 is desirably performed at a sufficiently low flow rate. In the drain process of the pure water, it is further desirable that a sufficient amount of superheated vapor is supplied to avoid pressure reduction in the chamber 2a.

When drainage of the pure water is completed, that is, when the result of step S33 is Yes, the substrate processing apparatus 1a switches the solenoid valve 40 to a closed state and stops heating of water vapor by the heater 41, to stop supply of the superheated vapor (step S34).

The substrate processing apparatus 1a subsequently performs nitrogen gas supply (step S35), which process is illustrated in FIG. 9. In this process, the solenoid valve 50 is placed in an open state for a certain period of time to supply nitrogen gas from the nitrogen supply part 5 for this period. The chamber 2a is thus placed in a nitrogen gas atmosphere which replaced the superheated vapor.

After the nitrogen gas supply process in step S35, the foregoing lid member is driven to open the chamber 2a. The transport mechanism not shown thereafter receives the substrate 90 held by the holding mechanism 3 and transports the same from the chamber 2a. The nitrogen gas supply process (step S35) is finished at this stage. That is, similar to the first preferred embodiment, the atmosphere in the chamber 2a is replaced by nitrogen gas prior to transportation of the substrate 90. It is thus allowed to suppress condensation of pure water which results in readhesion thereof to the substrate 90.

The substrate processing apparatus 1a then judges whether another objective substrate 90 exists (step S37). If these is another objective substrate 90, the process flow starting from step S21 is repeated to process this substrate 90. If these is no objective substrate 90, the open/close valves 61 and 62 are switched to a closed state to stop exhaustion of the atmosphere in the chamber 2a, and the heaters 20 stop heating the atmosphere in the chamber 2a (step S38). The process flow thereby ends.

As discussed, in the substrate processing apparatus 1a of the second preferred embodiment, while the pure water gathering in the chamber 2a is drained through the pipe 23, superheated vapor is supplied from the vapor supply part 4 to the chamber 2a. The substrate 90 is thus dried in a high temperature and low humidity atmosphere, whereby like the substrate processing apparatus 1 of the first preferred embodiment, the processing solution adhered to the substrate 90 can be rapidly removed by drying.

Further, the nitrogen supply part 5 for supplying nitrogen gas as inert gas to the chamber 2a provides a low oxygen concentration atmosphere in the chamber 2a, resulting in suppression of water mark formation.

Still further, nitrogen gas is supplied from the nitrogen supply part 5 to the chamber 2a prior to supply of superheated vapor from the vapor supply part 4 to the chamber 2a. That is, the chamber 2a is already placed in a low oxygen atmosphere at the time when superheated vapor is supplied thereto. As a result, water mark formation is suppressed even when such superheated vapor partially condenses.

Additionally, the nitrogen supply part 5 supplies nitrogen gas to the chamber 2a after the pure water gathering in the chamber 2a is drained through the pipe 23. Even on the occurrence of temperature drop in the chamber 2a as a result of opening of the chamber 2a to transport the substrate 90, condensation which results in readhesion of pure water is thus suppressed.

In the substrate processing apparatus 1a of the second preferred embodiment, relative positions of the liquid surface of pure water and the substrate 90 are changed by draining the pure water from the chamber 2a, whereby the substrate 90 is exposed to a high temperature and low humidity atmosphere. An alternative way, such as movement of the substrate 90, may be applicable for changing these relative positions to expose the substrate 90 to an appropriate atmosphere.

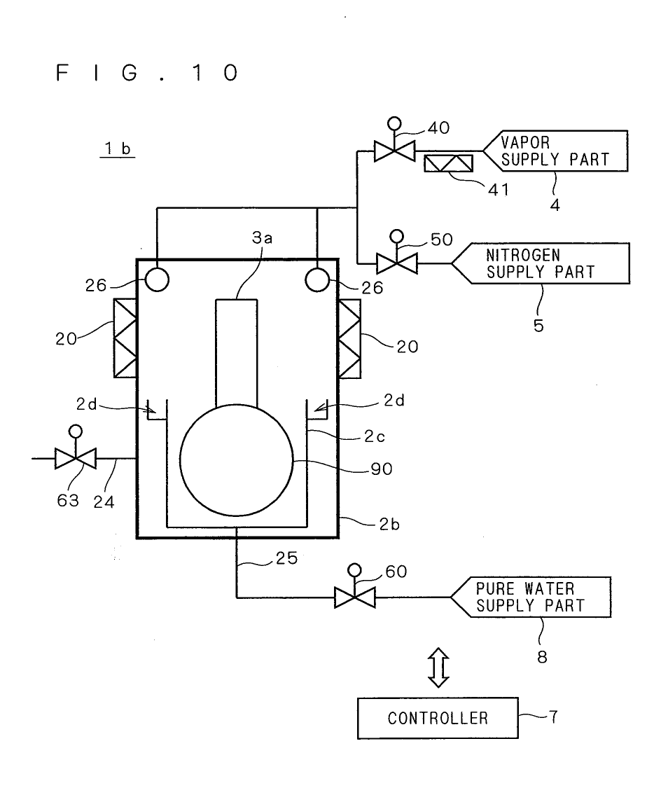

FIG. 10 illustrates a substrate processing apparatus 1b according to a third preferred embodiment of the present invention that is responsive to this principle.

The substrate processing apparatus 1b comprises a chamber 2b, a processing bath 2c, an exhaust pipe 24, a water supply pipe 25, a holding mechanism 3a, and an open/close valve 63. The substrate processing apparatus 1b comprises the substantially similar constituent parts in functionality to those of the substrate processing apparatus 1a. These parts are designated by the same reference numerals and the description thereof will be omitted, where appropriate.

The chamber 2b is operative to function as a processing chamber in which the substrate 90 is held to be isolated from the external atmosphere.

Purge pipes 26 as a pair are arranged in the upper portion of the chamber 2b, and are communicatively connected to the vapor supply part 4 and to the nitrogen supply part 5. The purge pipes 26, which have a tubular shape extending in a direction approximately vertical to the plane of the drawing of FIG. 6, are provided with slits or outlets, allowing a substance in gaseous form supplied the vapor supply part 4 or the nitrogen supply part 5 to be discharged to the chamber 2b.

The chamber 2b is provided with the exhaust pipe 24 having the open/close valve 63. By bringing the open/close valve 63 to an open state, the atmosphere in the chamber 2b is exhausted to outside.

A processing bath 2c, provided at the lower portion inside the chamber 2b, is operative to store pure water therein to immerse the substrate 90. The processing bath 2c is provided with drainage outlets 2d which receive and drain overflowing pure water. The drainage outlets 2d include pipes not shown communicatively connected thereto, through which the pure water overflowing from the processing bath 2c is drained to the outside of the chamber 2b. The water supply pipe 25 including the open/close valve 60 is provided at the bottom portion of the processing bath 2c. By bringing the open/close valve 60 to an open state, pure water is introduced from the pure water supply part 8 into the processing bath 2c.

The holding mechanism 3a is operative to hold the substrate 90, which function is similar to that of the holding mechanism 3 of the first and second preferred embodiments. While holding the substrate 90, the holding mechanism 3a is further operative to move the substrate 90 up and down in the chamber 2b. That is, while holding the substrate 90, the holding mechanism 3a downwardly moves the substrate 90 to locate the substrate 90 in the processing bath 2c.

The main configuration of the substrate processing apparatus 1b of the third preferred embodiment is as described above. The operation of the substrate processing apparatus 1b will be discussed next.

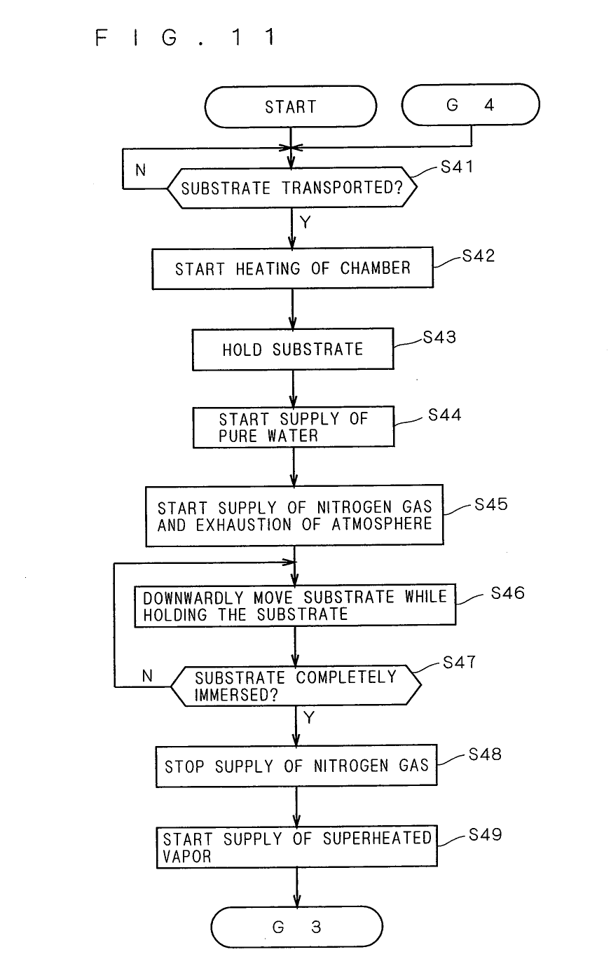

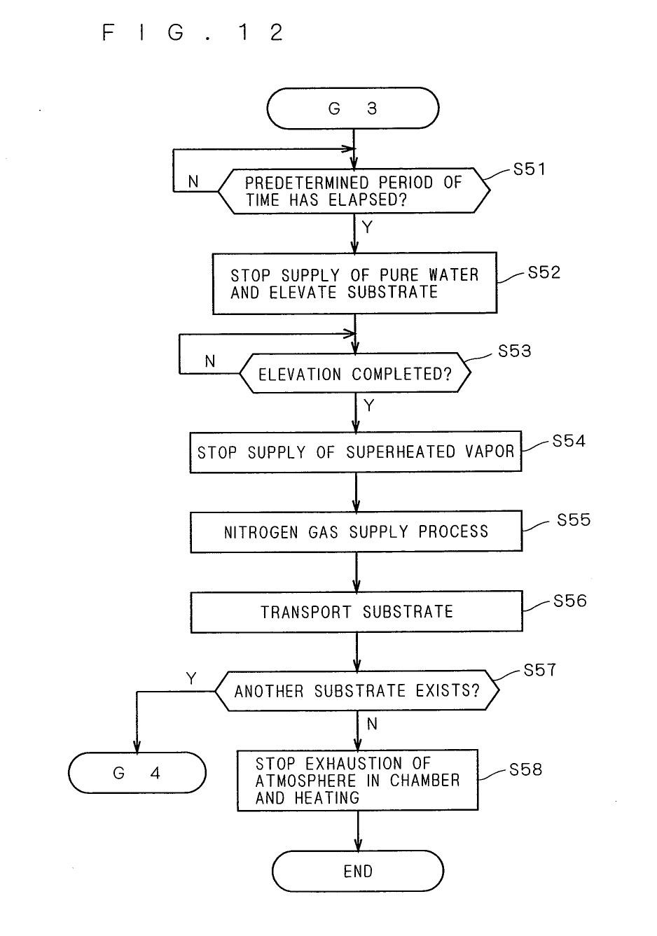

FIGS. 11 and 12 are flowcharts showing the operation of the substrate processing apparatus 1b of the third preferred embodiment. FIGS. 13 through 17 schematically illustrate states of the chamber 2b and the processing bath 2c when the substrate processing apparatus 1b is in an operating state.

First, step S41 brings the substrate processing apparatus 1b to a standby state, which state continues until the substrate 90 is transported to the chamber 2b. When the substrate 90 is transported to the chamber 2b, the heaters 20 start heating of the atmosphere in the chamber 2b (step S42) and the holding mechanism 3a holds the substrate 90 at a predetermined position (step S43).

Next, the open/close valve 60 is brought to an open state to start supply of pure water from the pure water supply part 8 to the processing bath 2c through the water supply pipe 25 (step S44). The solenoid valve 50 is also brought to an open state to supply nitrogen gas from the nitrogen supply part 5 to the chamber 2b (step S45). Concurrently with these supply processes, the open/close valve 63 is brought to an open state to exhaust the atmosphere in the chamber 2b through the exhaust pipe 24. The external atmosphere (mainly containing air) introduced into the chamber 2b as a result of transportation of the substrate 90 to the chamber 2b is thereby replaced by nitrogen gas, to provide a low oxygen atmosphere in the chamber 2b. Supply of nitrogen gas by the nitrogen supply part 5 continues until to-be-discussed step S48.

Thereafter, the holding mechanism 3a holding the substrate 90 starts to downwardly move the substrate 90 (step S46), whereby the liquid level of the pure water in the processing bath 2c rises relative to the substrate 90 to gradually immerse the substrate 90 in the pure water. Step S46 may be started after a predetermined amount of pure water is supplied from the pure water supply part 8 to the processing bath 2c. The holding mechanism 3a repeats step S46 to continue to downwardly move the substrate 90 until the substrate 90 is completely immersed in the pure water (step S47).

FIG. 13 illustrates how the substrate 90 is held in the processing bath 2c by the holding mechanism 3a. The liquid level of the pure water rises up to the height of the upper end of the processing bath 2c, thus causing overflow of the pure water. The overflowing pure water is drained through the drainage outlets 2d to the outside of the chamber 2b. The substrate 90 is completely immersed in the pure water stored in the processing bath 2c at this time, and therefore, the result of step S47 is Yes.

When the substrate 90 is completely immersed in the pure water, that is, when the result of step S47 is Yes, the substrate processing apparatus 1b switches the solenoid valve 50 to a closed state to stop supply of nitrogen gas (step S48). Supply of nitrogen gas may be stopped in step S48 at the time when the nitrogen gas has sufficiently replaced the atmosphere in the chamber 2b.

Next, the substrate processing apparatus 1b starts heating of water vapor by the heater 41 and brings the solenoid valve 40 to an open state, to thereby start supply of superheated vapor from the vapor supply part 4 (step S49). Supply of superheated vapor to the chamber 2b continues until to-be-discussed step S54.

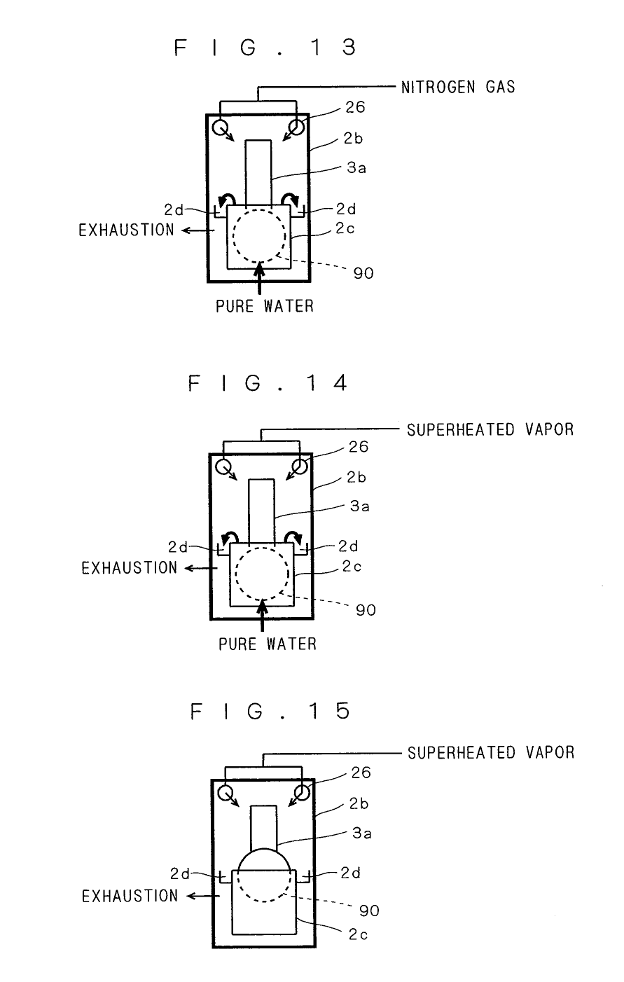

FIG. 14 illustrates a state in which supply of superheated vapor to the chamber 2b is started. At this stage, the pure water supply part 8 continues to supply pure water. The pure water overflowing from the upper portion of the processing bath 2c is drained from the chamber 2b. The substrate processing apparatus 1b is placed in a standby state for a prescribed period of time during supply of the superheated vapor (step S51). The atmosphere in the chamber 2b is thus replaced by the superheated vapor.

After the prescribed period of time has elapsed, the controller 7 switches the open/close valve 60 to a closed state to stop supply of pure water. The controller 7 also causes the holding mechanism 3a to start upwardly moving the substrate 90 (step S52). FIG. 15 illustrates how the holding mechanism 3a upwardly moves the substrate 90. As a result of this upward movement of the substrate 90 by the holding mechanism 3a, the substrate 90 is taken out of the processing bath 2c. That is, this upward movement of the substrate 90 changes the relative positions of the liquid surface of the pure water gathering in the processing bath 2c and the substrate 90, to thereby gradually expose the surface of the substrate 90 to the atmosphere in the chamber 2b. The pure water adhered to the substrate 90 thereby evaporates in a short period of time by the superheated vapor. That is, such pure water is removed from the surface of the substrate 90 by drying. During this evaporation, the vapor supply part 4 continuously supplies superheated vapor. The atmosphere experiences rise in humidity as a result of this removal of the pure water, which atmosphere is exhausted through the exhaust pipe 24 accordingly. Reduction in drying efficiency is thereby avoided.

As discussed, in the substrate processing apparatus 1b of the third preferred embodiment, the substrate 90 is dried in an atmosphere which has been replaced in advance by nitrogen gas and superheated vapor. Like the substrate processing apparatus 1a of the second preferred embodiment, it is thus allowed to dry the substrate 90 in a low oxygen atmosphere, resulting in suppression of water mark formation.

The chamber 2b is heated by the heaters 20 in the process flow, and therefore, temperature drop of the atmosphere in the chamber 2b is controlled in the drying process of the substrate 90. As a result, the pure water (processing solution) adhered to the substrate 90 can be removed by drying with a high degree of efficiency.

The heater 41 generates superheated vapor from water vapor which is then supplied to the chamber 2b, and therefore, the chamber 2b can be placed in a high temperature and low humidity atmosphere which is suitably applied for drying. As a result, pure water can dry with a higher degree of efficiency and the atmosphere is provided with an enhanced heat capacity, leading to improved control of temperature drop.

If the substrate 90 is rapidly lifted from pure water, relatively large water droplets may be adhered to the surface of the substrate 90, leading to reduction in drying efficiency and poor drying. In response, the holding mechanism 3a desirably moves the substrate 90 upwardly at a sufficiently low speed.

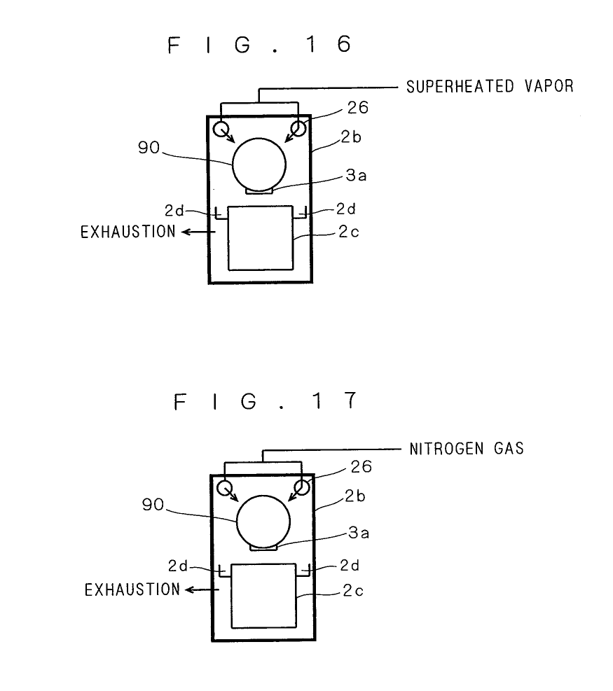

FIG. 16 illustrates a state in which the upward movement of the substrate 90 by the holding mechanism 3a is finished. When the upward movement of the substrate 90 is completed, that is, when the result of step S53 is Yes, the substrate processing apparatus 1b switches the solenoid valve 40 to a closed state and stops heating of water vapor by the heater 41, to stop supply of the superheated vapor (step S54).

The substrate processing apparatus 1b subsequently performs nitrogen gas supply (step S55), which process is illustrated in FIG. 17. Like the nitrogen supply process of step S35, the solenoid valve 50 is placed in an open state for a certain period of time to supply nitrogen gas from the nitrogen supply part 5 for this period. The chamber 2b is thus placed in a nitrogen gas atmosphere which replaced the superheated vapor.

After the nitrogen gas supply process in step S55, the foregoing lid member is driven to open the chamber 2b. The transport mechanism not shown thereafter receives the substrate 90 which is held by the holding mechanism 3a at an elevated position, and transports the same from the chamber 2b (step S56). The atmosphere in the chamber 2b is replaced by nitrogen gas by the nitrogen gas supply process prior to transportation of the substrate 90. It is thus allowed to suppress condensation of pure water which results in readhesion thereof to the substrate 90.

The substrate processing apparatus then judges whether another objective substrate 90 exists (step S57). If there is another objective substrate 90, the process flow starting from step S41 is repeated to process this substrate 90. If there is no objective substrate 90, the open/close valve 63 is switched to a closed state to stop exhaustion of the atmosphere in the chamber 2b, and the heaters 20 stop heating the atmosphere in the chamber 2b (step S58). The process flow thereby ends.

As discussed, in the substrate processing apparatus 1b of the third preferred embodiment, superheated vapor is supplied from the vapor supply part 4 to the chamber 2b during upward movement of the substrate 90 by the holding mechanism 3a, which also provides a high temperature and low humidity atmosphere for drying the substrate 90. Like the second preferred embodiment, it is allowed accordingly to rapidly remove the processing solution adhered to the substrate 90 by drying.

In the substrate processing apparatus 1 of the first preferred embodiment, only pure water is applicable in the cleaning process of the chamber 2 in step S13. However, a chemical solution may also be used for cleaning. That is, the substrate processing apparatus 1 may comprise a mechanism for supplying a chemical solution for cleaning to the chamber 2 such as an APM (ammonia-hydrogen peroxide mixture) or an HPM (hydrochloric acid-hydrogen peroxide mixture), in which case such a mechanism discharges a chemical solution onto the substrate 90 after the cleaning process of step S13, and thereafter, a cleaning process similar to the one of step S13 is performed.

In the first preferred embodiment, further, nitrogen gas is supplied from the nitrogen supply part 5 to the chamber 2 after the atmosphere in the chamber 2 is released in the external atmosphere. However, supply of nitrogen gas may be timed to occur at another stage. As an example, supply of nitrogen gas from the nitrogen supply part 5 may be started at the time when the lid member of the chamber 2 is closed to hermetically seal the chamber 2, that is, when step S12 is executed. In this case, the open/close 6 may be brought to an open state to exhaust the atmosphere in the chamber 2 by suction concurrently with supply of nitrogen gas from the nitrogen supply part 5. The atmosphere introduced into the chamber 2 as a result of transportation of the substrate 90 (which is generally air containing oxygen) is thereby replaced in advance by nitrogen gas. As a result, the chamber 2 is placed in a low oxygen atmosphere, leading to suppression of water mark formation to a greater degree.

While the invention has been shown and described in detail, the foregoing description is in all aspects illustrative and not restrictive. It is therefore understood that numerous modifications and variations can be devised without departing from the scope of the invention.

What is claimed is:

1. A substrate processing method for drying a processing solution adhered to a substrate, comprising the steps of:
(a) holding a substrate in a processing chamber which isolates an ambient atmosphere of a substrate from outside;
(b) realizing rise in temperature and pressure in said processing chamber;
(c) releasing an atmosphere in said processing chamber when said processing solution in said processing chamber is placed at a temperature which is a boiling point of said processing solution in an external atmosphere or higher existing outside said processing chamber; and
(d) supplying inert gas to said processing chamber,
wherein said step (b) comprises the step of:
(b-1) supplying vapor to said processing chamber, to thereby realize rise in temperature and pressure in said processing chamber, said vapor being generated from a solution which is of the same type as said processing solution.

2. The method according to claim 1, further comprising the step of:
(e) draining said processing solution from said processing chamber.

3. The method according to claim 1,
wherein said processing solution is pure water,
wherein said external atmosphere is the atmosphere, and
wherein said step (c) comprises the step of:
(c-1) releasing an atmosphere in said processing chamber when said pure water in said processing chamber is placed at a temperature which is 100 degrees centigrade or higher.

4. A substrate processing method for performing predetermined processing on a substrate, comprising the steps of:
(a) holding a substrate in a processing chamber capable of isolating an atmosphere therein from outside;
(b) while a substrate is immersed in a processing solution in said processing chamber, supplying vapor to said processing chamber which is generated from a solution of the same type as said processing solution;
(c) while said vapor is supplied to said processing chamber, draining said processing solution stored in said processing chamber; and
(d) supplying inert gas to said processing chamber after said step (c),
wherein said step (b) comprises the step of:
(b-1) exhausting said processing chamber.

5. The method according to claim 4,
wherein said step (d) comprises the step of:
(d-1) exhausting said processing chamber.

6. The method according to claim 4, further comprising the step of:
(e) supplying inert gas to said processing chamber prior to said step (b).

7. The method according to claim 6,
wherein said processing chamber is exhausted in said step (e).

8. The method according to claim 4,
wherein said processing chamber is heated in said steps (a), (b) and (c).

9. The method according to claim 4,
wherein said step (b) comprises the step of:
(b-2) heating said vapor to supply the heated vapor to said processing chamber.
